(19) United States
(12) Patent Application Publication
(10) Pub. No.: US 2025/0328475 A1
(43) Pub. Date: Oct. 23, 2025

(54) DEVICE AND METHOD WITH SINGLE-LEVEL PAGE TABLE FOR OBTAINING PHYSICAL ADDRESSES

(71) Applicant: Samsung Electronics Co., Ltd., Suwon-si (KR)

(72) Inventors: Jungsik CHOI, Suwon-si (KR); Seok-Young YOON, Suwon-si (KR)

(73) Assignee: Samsung Electronics Co., Ltd., Suwon-si (KR)

(21) Appl. No.: 18/945,080

(22) Filed: Nov. 12, 2024

(30) Foreign Application Priority Data
Apr. 23, 2024 (KR) 10-2024-0054126

(51) Int. Cl. G06F 12/1027; G06F 12/02; G06F 12/1009

(52) U.S. Cl. CPC G06F 12/1027; G06F 12/0246; G06F 12/1009

(57) ABSTRACT

An electronic device and method with a single-level page table for obtaining physical addresses are disclosed. The operating method includes determining, in response to a process being executed, whether a mapping of a target physical address to a virtual address that the process is accessing is stored in a translation lookaside buffer (TLB); determining, in response to determining that the virtual address is not stored in the TLB, whether the process uses a single-level page table; and in response to determining that the process uses the single-level page table, obtaining the target physical address mapped to the virtual address based on accessing the single-level page table.

### CROSS-REFERENCE TO RELATED APPLICATIONS

This application claims the benefit under 35 USC § 119(a) of Korean Patent Application No. 10-2024-0054126, filed on Apr. 23, 2024, in the Korean Intellectual Property Office, the entire disclosure of which is incorporated herein by reference for all purposes.

### BACKGROUND

### 1. Field

The following description relates to a device method with a single-level page table for obtaining physical addresses.

### 2. Description of Related Art

Virtual memory allows execution of programs having size that exceeds the size of main physical memory in a computer system. Virtual memory may provide a program or process with a memory space larger than physical memory, allowing a program to run without having to directly access the physical memory. In addition, a virtual memory system may provide each process with its own independent virtual address space. Thus, virtual memory may prevent a process from interfering with the memory of another process, thereby enhancing stability and security of the computer system. In addition, the virtual memory may allow a programmer to write a program without concern for the size of main memory.

In other words, virtual memory systems simplify program development by efficiently using memory resources and enhancing security and stability.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an operating method of an electronic device includes: determining, in response to a process being executed, whether a mapping of a target physical address to a virtual address that the process is accessing is stored in a translation lookaside buffer (TLB); determining, in response to determining that the virtual address is not stored in the TLB, whether the process uses a single-level page table; and in response to determining that the process uses the single-level page table, obtaining the target physical address mapped to the virtual address based on accessing the single-level page table.

The determining of whether the process uses a single-level page table may be based on a register bit indicating a type of the process.

The bit may be set by a system call invoked based on a user command that causes the process to be executed using the single-level page table.

The operating method may further include: determining, in response to a second process being executed, whether a mapping of a second target physical address to a second virtual address that the second process is accessing is stored in the TLB; determining, in response to determining that the second virtual address is not stored in the TLB, whether the second process uses a single-level page table; and in response to determining that the second process does not use a single-level page table, obtaining the second target physical address mapped to the second virtual address based on a multi-level page table.

A page size of the multi-level page table may be less than a page size of the single-level page table.

Each level of the multi-level page table may have a page size larger than each level below it.

A virtual address space of the electronic device may be divided into a kernel space and a user space, processes in the kernel space may use multi-level page tables, and processes in the user space may use single-level page tables.

The determining of whether the process uses a single-level page table may depend on whether the virtual address is in the user space or is in the kernel space.

In another general aspect, an electronic device includes one or more host processors configured to: determine, in response to a process being executed, whether a mapping of a target physical address to a virtual address that the process is accessing is stored in a translation lookaside buffer (TLB); determine, in response to determining that the virtual address is not stored in the TLB, whether the process uses a single-level page table; and in response to determining that the process uses the single-level page table, obtain the target physical address mapped to the virtual address based on accessing the single-level page table.

The one or more host processors may be further configured to: determine, based on a bit in a page table register (PTR), that the process uses the single-level page table, wherein the electronic device is configured to perform a single-level page table walk when the bit has a first value and is configured to perform a multi-level page table walk when the bit has a second value.

The bit may be set by a system call invoked based on a user command that causes the process to be executed using the single-level page table.

The one or more host processors may be configured to: determine, in response to a second process being executed, whether a mapping of a second target physical address to a second virtual address that the second process is accessing is stored in the TLB; determine, in response to determining that the second virtual address is not stored in the TLB, whether the second process uses a single-level page table; and in response to determining that the second process does not use a single-level page table, obtain the second target physical address mapped to the second virtual address based on a multi-level page table.

A page size of the multi-level page table may be less than a page size used by the single-level page table.

Each level of the multi-level page table may have a page size larger than each level below it.

A virtual address space of the electronic device may be divided into a kernel space and a user space, processes in the kernel space may use multi-level page tables, and processes in the user space may use single-level page tables.

The determining that the process uses a single-level page table may depend on whether the virtual address is in the user space or is in the kernel space.

In another general aspect, a method performed by a computing device includes: determining whether processes executing on the computing device use single-level page tables or whether they user multi-level page tables; for each process determined to use a single-level page table, when a requested virtual address is not found in a translation lookaside buffer (TLB), using a corresponding single-level page table to determine the requested virtual address; and for each processed determined to use a multi-level page table, when a requested virtual address is not found in the TLB, using a corresponding multi-level page table to determine the requested virtual address.

The method may further include using a single-level page table to perform a first update of the TLB to include a mapping of a corresponding requested virtual address.

The method may further include using a multi-level page table to perform a second update of the TLB to include a mapping of a corresponding requested virtual address.

Bit values of a page table register may be checked, for the respective processes, to determine which of the processes use a corresponding single-level page table and which of the processes use a corresponding multi-level page table.

Other features and aspects will be apparent from the following detailed description, the drawings, and the claims.

### BRIEF DESCRIPTION OF THE DRAWINGS

FIG. 1 illustrates an example of an electronic device, according to one or more embodiments.

FIG. 2 illustrates an example of a host processor, according to one or more embodiments.

FIGS. 3 and 4 illustrate examples of a page table walk, according to one or more embodiments.

FIG. 5 illustrates an example of an operating method of an electronic device, according to one or more embodiments.

FIG. 6 illustrates an example of code flow for creation of a process, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

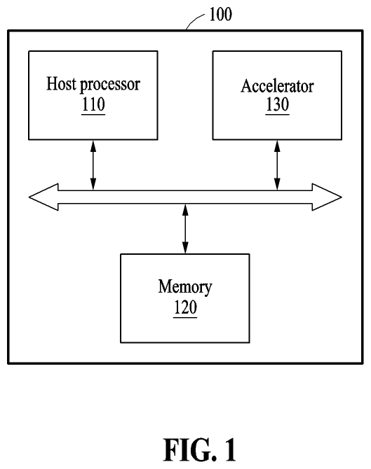

FIG. 1 illustrates an example of an electronic device, according to one or more embodiments.

Referring to FIG. 1, an electronic device 100 may include a host processor 110, a memory 120, and an accelerator 130. The host processor 110, the memory 120, and the accelerator 130 may communicate with each other through a bus, a network on a chip (NoC), a peripheral component interconnect express (PCIe), and/or the like. Only components of the electronic device 100 (or “computing device”) related to the examples and embodiments described herein are shown in FIG. 1; the electronic device 100 may further include other general-purpose components in addition to the components illustrated in FIG. 1.

The host processor 110 may perform overall functions for controlling the electronic device 100. The host processor 110 may control the electronic device 100 overall by executing programs and/or instructions stored in the memory 120. The host processor 110 may control the execution of programs/processes/threads and their use of resources of the electronic device 100 by executing an operating system, which may include a memory management unit (MMU) or the like. The host processor 110 may be implemented as a central processing unit (CPU), a graphics processing unit (GPU), an application processor (AP), and/or combinations of the like that are included in the electronic device 100. However, examples are not limited thereto.

The memory 120 may be hardware for storing data that is to be processed or that has been processed in the electronic device 100. In addition, the memory 120 may store an application or a driver to be driven by the electronic device 100. The memory 120, which may also be referred to as physical memory or host memory, may include a volatile memory (e.g., dynamic random-access memory (DRAM)) and/or a non-volatile memory.

The electronic device 100 may include an accelerator 130 for an operation. The accelerator 130 may process tasks that, due to the characteristics of the tasks, may be more efficiently processed by a separate dedicated processor, such as the accelerator 130, than by a general-purpose processor, that is, the host processor 110. In this case, one or more processing elements (PEs) included in the accelerator 130 may be used. The accelerator 130 may correspond to, for example, a neural processing unit (NPU), a tensor processing unit (TPU), a digital signal processor (DSP), a GPU, a neural engine, or the like, some of which may be capable of performing an operation for implementing a neural network.

The electronic device 100 may use a virtual memory to execute a program with a memory need larger than a size of the physical memory 120. The virtual memory may be implemented based on a page table. The page table may include mapping information between virtual addresses and physical addresses.

In general, the electronic device 100 may manage the memory 120 using a demand paging policy (e.g., as implemented by an MMU). Demand paging policy generally involves loading a page into the memory 120 from a backing store (e.g., a non-volatile storage) only when necessary (e.g., when its data is accessed), rather than loading an entire program and/or its data into the memory 120 at the same time. Since the electronic device 100 may use the demand paging policy, a page fault may occur when a page that is to be accessed is in the backing store and not in the memory 120. When the electronic device 100 accesses a target physical address by referencing the page table but the corresponding page of the target physical address is not residing in the memory 120, then a page fault may occur as the target physical address is not written.

The electronic device 100 may use a single-level page table or a multi-level page table to efficiently manage the memory 120. The electronic device 100 may obtain a target physical address mapped to a virtual address by performing a page table walk on a single-level page table or a multi-level page table.

When the electronic device 100 performs a page table walk on a multi-level page table, very large overhead may occur. Translating a virtual address to a physical address may be an important process. Whenever an instruction is executed, a virtual address referenced by the instruction may need to be translated (dereferenced) to a physical address. Thus, translating a virtual address to a physical address may be an important process. However, as described above, there may be a problem of overhead occurring when performing a page table walk on a multi-level page table to find the physical address.

The electronic device 100 may be a server in a data center. Here, the electronic device 100 may use a virtualization system (e.g., a type that provides virtual machines, partitions for virtual machines, or the like). In the virtualization system, a virtual address may be translated to a physical address using a nested page table between a guest operating system (OS) and a host OS. In other words, in the virtualization system, a target address may be obtained by performing a page table walk on a multi-level page table of the guest OS to translate the virtual address to the target address. Here, the target address may be a virtual address of the host OS (which appears as a physical address to the guest OS). Thus, in the virtualization system, the corresponding target physical address may be obtained by performing a page table walk on a multi-level page table of the host OS to obtain the target physical address. In this case, a maximum of 26 memory accesses (i.e., 26 page table walks) may occur, for example. This many table walks may significantly increase latency of the guest OS's memory access.

Thus, a delay time for translating the virtual address to the physical address in the virtualization system may be very large, and when translation occurs frequently, very large overhead may occur in the entire system.

Hereinafter, a host processor that performs a page table work is described.

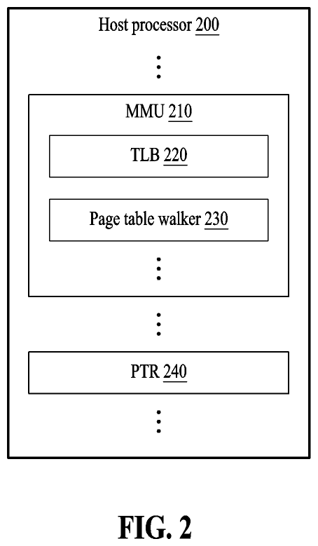

FIG. 2 illustrates an example of a host processor, according to one or more embodiments.

Referring to FIG. 2, a host processor 200 is shown. A description of the host processor 200 is generally the same as the description of the host processor 110 provided above with reference to FIG. 1.

The host processor 200 may include/execute a memory management unit (MMU) 210. The MMU 210 may translate virtual addresses to physical addresses using page tables.

The MMU 210 may translate a virtual address to a physical address by referencing a translation lookaside buffer (TLB) 220. The TLB 220 may store mapping information between recently translated virtual addresses and their associated physical addresses. When a virtual address to be translated by referencing the TLB 220 is present in the TLB 220 (i.e., in the case of TLB hit), the MMU 210 may obtain a physical address mapped to the virtual address directly from the TLB 220.

When a virtual address to be translated by referencing the TLB 220 is not present in the TLB 220 (i.e., in the case of TLB miss), the MMU 210 may perform a page table walk to obtain the physical address that is mapped to the virtual address. The MMU 210 may perform a page table walk on a page table using a page table walker 230.

A page table register (PTR) 240 may store a page table address of a currently running process. The PTR 240 may vary depending on architecture. For example, in the x86 architecture, the PTR 240 may be control register 3, or CR3. For example, in the case of the RISC-V architecture, the PTR 240 may be a supervisor address translation and protection (satp) register. The PTR 240 may store a pointer that points to a page table of the currently running process. That is, the PTR 240 may be used in the process of translating a virtual address to a physical address.

Reducing the occurrence of TLB misses may reduce the occurrences of page table walks, thereby reducing overhead. In order to do this, the size of a TLB may need to be increased. However, since a physical size may also increase when increasing the size of a TLB, there may be a limit to increasing the size of a TLB. In other words, there may be a limit to enhancing TLB reach (the amount of memory accessible via a TLB) by increasing the size of a TLB.

As a result, modern applications may have a problem in that 20% to 50% of a total execution time may be used for address translation, and page table walking may take up 20% to 40% of the address translation time.

Hereinafter, a page table walk for a multi-level page table is described.

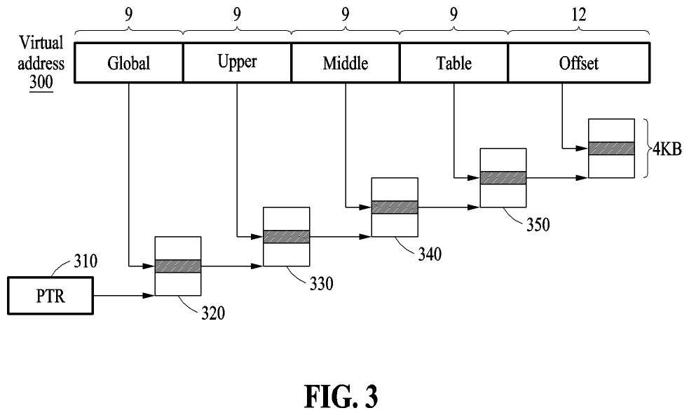

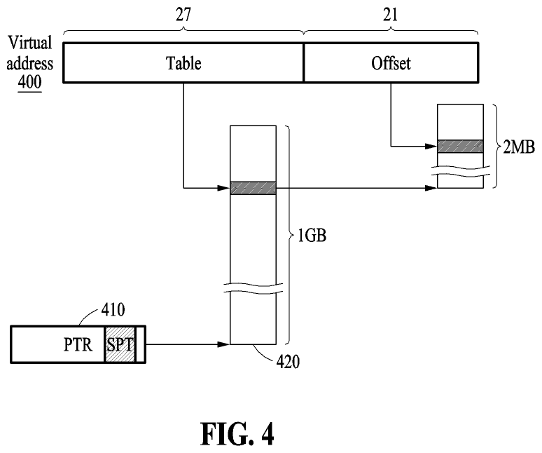

FIGS. 3 and 4 illustrate examples of a page table walk, according to one or more embodiments.

Referring to FIG. 3, a page table walk for a 4-level page table using a page having a size of 4 KB is shown. The page table walk may be performed by a page table walker (e.g., page table walker 230). However, the following description may equally apply to page table walking for a page table with the second level or above.

Referring to FIG. 3, a virtual address 300 for execution of a process is shown. It is assumed that the virtual address 300 is expressed in 48 bits, as a non-limiting example.

A PTR 310 may point to a global directory 320 of a multi-level page table used by the process. Data stored in the PTR 310 may vary for each process. The electronic device may determine a global directory entry in the global directory 320 pointed by the PTR 310 based on a 9-bit global index portion of the virtual address 300. The electronic device may determine, from the determined global directory entry, an upper directory 330 mapped to the 9-bit global index.

The electronic device may determine an upper directory entry from the upper directory 330 based on a 9-bit upper index portion of the virtual address 300. The electronic device may determine, from the determined upper directory entry, a middle directory 340 mapped to the 9-bit upper index portion.

The electronic device may determine a middle directory entry from the middle directory 340 based on a 9-bit middle index portion of the virtual address 300. The electronic device may determine, from the middle directory entry, a page table 350 mapped to the 9-bit middle index portion.

The electronic device may determine a page table entry from the page table 350 based on a 9-bit page table index portion of the virtual address 300. The electronic device may determine, from the page table entry, a physical page 360 mapped to the 9-bit page table index portion.

A remaining portion of the virtual address 300, the offset portion of the virtual address 300, may point to a physical page. The electronic device may use an offset to access memory in the unit of byte/word rather than in the unit of page. That is, a 12-bit offset may point to a physical address in a physical page. In other words, the 12 bits may index a location within a physical page having a size of 4 KB in the unit of byte.

In sum, in the case of a 4-level page table, a 4-level page walk (i.e., 4 page accesses) may be performed to translate a virtual address to a physical address of a desired byte/word.

A reason for using a multi-level page table may be that a size of the page table may be reduced. As noted, virtual memory may use a demand paging policy. In other words, only the pages that are immediately/recently needed may be loaded into main memory. Accordingly, the electronic device may only need to maintain a page table for the immediately needed pages loaded on the main memory. Notably, a page table with an empty page table entry may be effectively managed by reducing the size of the page table using a multi-level page table.

The electronic device may be a high-performance computing (HPC) system. Since an HPC system does not generally use a demand paging policy due to the latency problem, the size of its page table cannot be effectively reduced even when a multi-level page is used. In an HPC system, it may be important to match data to be used to the size of main memory and prevent swap in/out from occurring (if the needed data is in main memory, no swapping is needed). Therefore, in an HPC system, mapping for all pages may be pre-populated. As a result, it may be difficult to reduce the size of the page table by the size of the empty page table entries.

Thus, when there is no advantage (i.e., reduction in the page table size) in using a multi-level page table like in the case of an HPC system, it may be better to use a single-level page table, which may minimize the delay time of address translation. When using a single-level page table, unlike a multi-level page table, address conversion may be performed with only one access (i.e., one page table walk).

Next, a page table walk for a single-level page table is described.

Referring to FIG. 4, a page table walk for a single-level page table using a page having a size of 2 MB is shown. The page table walk may be performed by a page table walker.

Referring to FIG. 4, a virtual address 400 for execution of a process is shown (e.g., an address of an instruction or data). It is assumed that the virtual address 400 is expressed in 48 bits, as a non-limiting example.

A PTR 410 may optionally point to a single-level page table 420. In order for the PTR 410 to point to the single-level page table 420, a separate bit may be stored in the PTR 410. The separate bit, or flag, may be stored in a special page table (SPT) flag of the PTR 410. The SPT flag may refer to one of the 5th to 11th bits of the PTR 410, as an example. In other words, a bit (or bits) in the SPT flag may indicate whether the SPT points to a single-level page table or points to a multi-level page table. The SPT flag may be used for arbitrary PTRs to distinguish between single-level and multi-level page tables. When a separate bit is stored in the SPT flag, a page table address stored in the PTR 400 may interpreted as pointing to the single-level page table 420. When no separate bit is stored in the SPT flag, the page table address stored in the PTR 400 may be interpreted as pointing to a specific directory (e.g., a global directory in the case of a 4-level page table) in the multi-level page table. The SPT flag is only a notation for ease of description, and the present disclosure is not limited thereto.

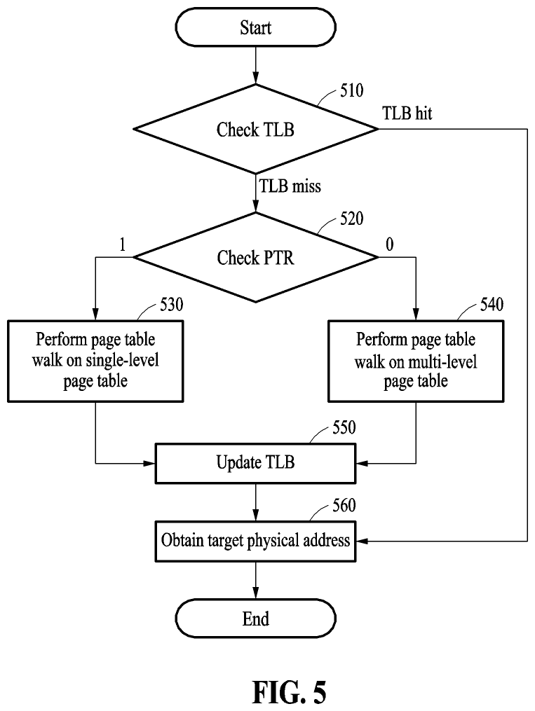

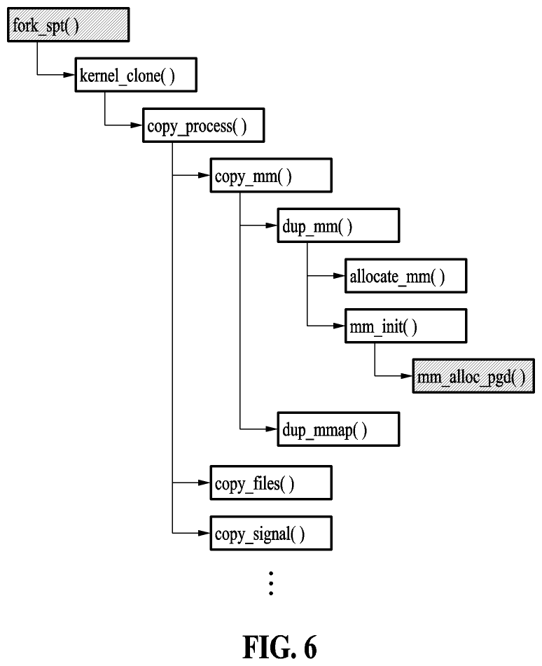

Use of the SPT flag is described with reference to FIGS. 5 to 6.

In the case of the PTR corresponding to a single-level page table 420, a physical address mapped to the virtual address 400 may be obtained through one page table walk, thereby reducing overhead. Hereinafter, an effect of increasing a page size is described, which may be an advantage of using a single-level page table.

It is assumed, as a non-limiting example, that the virtual address 400 is expressed in 48 bits. In this example, the virtual address 400 represents an address space of 256 TB (i.e., 2⁴⁸). When 256 TB of address space is managed for 2 MB pages (i.e., each page is of size 2²¹), 2²⁷ pages may be needed. In this case, a page table entry pointing to the physical page in a page table may have a size of 8 Bytes (i.e., 2³). Thus, since 2²⁷ page table entries of 8 Bytes (i.e., 2³) may be needed, 1 GB (2³⁰) of memory may be needed to configure a single-level page table. In other words, the page table may only occupy 1 GB in memory to provide addressing for 256 TB of memory.

On the other hand, a case in which the single-level page table uses a 4 KB (i.e., 2¹²)-size page is as follows. The virtual address 400 may be expressed in 48 bits. In other words, the virtual address 400 may represent an address space of 256 TB (i.e., 2⁴⁸). When 256 TB is managed with 4 KB (i.e., 2¹²) pages, 2³⁶ pages may be needed. Here, since the page table entry has a size of 8 Bytes (i.e., 2³), 512 GB (i.e., 2³⁹) of memory may be needed to configure a single-level page table. In other words, the page table may occupy 512 GB in the memory.

To execute a process, the page table may need to be loaded on the memory. In other words, a size of a single-level page table using a large-sized page may be much less than a size of a single-level page table using a small-sized page and may thus have an advantage of occupying less memory, with the disadvantage of having a larger page size.

However, when a single-level page table is used for all processes in a system, there may be no advantage to be gained by the small size of the page table. There may be hundreds to thousands of processes used in a system. Accordingly, hundreds to thousands of GB of memory may be needed.

Thus, it may be necessary to minimize a delay time of address translation by using the single-level page table only for key or suitable processes. In other words, it may be necessary to perform address translation using a multi-level page table for auxiliary processes and using a single-level page table for main processes to efficiently manage memory.

Next, an operating method of an electronic device for obtaining a physical address using a single-level page table or a multi-level page table is described.

FIG. 5 illustrates an example of an operating method of an electronic device, according to one or more embodiments. Operations 510 to 560 may be performed by at least one component of the electronic device.

In operation 510, for a request to access a target physical address, the electronic device may check the TLB.

When a process is being executed, the electronic device may check the TLB to confirm whether a mapping of the target physical address associated with a virtual address that the process is about to access is stored in the TLB. When a process accesses memory, a process of translating the virtual address to a physical address mapped to the corresponding virtual address may be required. When a process accesses memory, the electronic device may, as in operation 510, determine whether the physical address for the virtual address to be accessed is cached in the TLB.

When there is a “TLB hit”, i.e., a mapping between the virtual address that the process is about to access and the physical address is stored (i.e., cached) in the TLB, the electronic device may perform operation 560 in response, that is, obtaining the target physical address from the TLB. On the other hand, when the mapping between the virtual address that the process is attempting to access and the physical address is not stored in the TLB (i.e., in the case of “TLB miss”), the electronic device may perform operation 520.

In operation 520, the electronic device may check a PTR associated with the process.

The electronic device may check a pre-designated SPT bit in the PRT that indicates whether the process uses a single-level page table or a multi-level page table. The electronic device may perform operation 530 when a bit value of the pre-designated bit (i.e., the SPT flag) is 1. The electronic device may perform operation 540 when the pre-designated SPT bit of the PRT has a value that is 0.

A bit indicating whether a single-level page table or a multi-level page table is used may be set by a specific system call. The specific system call is described with reference to FIG. 6.

When a main process is executed, the bit indicating whether the main process uses a single-level page table or a multi-level page table in the PTR may be updated to 1. When an auxiliary process is executed, the bit indicating whether the auxiliary process uses a single-level page table or a multi-level page table in the PTR may be updated to 0. That is, the bit may be updated to 1 when the type of the process is a main process, and the bit may be updated to 0 when the type of the process is an auxiliary process.

In other words, in operation 520, the electronic device may determine whether the type of the process being executed is a main process or an auxiliary process.

Since a specific process is a main process, the bit of the PTR may be updated to 1 based on a system call mapped to a user command to run the specific process as a main process. A user command to run a specific process as a main process may be distinguished from a user command to run a specific process as an auxiliary process (i.e., a normal process). For example, an electronic device may obtain a user command to run a specific process as a main process in a different way (e.g., receiving an execution command through a separate button or launch program to run a main process or the like) from a user command to run a specific process as an auxiliary process.

The electronic device may divide a virtual address space into a kernel space and a user space when using the virtual address space. The kernel space may be a virtual memory space used by an OS. The user space may be a virtual memory space used by an application. When the virtual address is determined to be a virtual address corresponding to the kernel space (i.e., when the process is executed in the kernel space), the bit of the PTR may be updated to 0. On the other hand, when the virtual address is a virtual address corresponding to the user space (i.e., when the process is executed in the user space), the bit of the PTR may be updated to either 0 or 1. That is, when the virtual address corresponds to the user space, the bit of the PTR may be updated to 0 or 1 depending on the judgment regarding whether the subject process is a main process or an auxiliary process.

In operation 530, the electronic device may perform a page table walk on a single-level page table.

The description of the method of performing a page table walk on a single-level page table provided above with reference to FIG. 4 is generally applicable. When performing a page table walk on a single-level page table, to take advantage of using a single-level page table, a page size of the single-level page table may be greater than a page size of the multi-level page table used in operation 540.

In operation 540, when the PTR check finds a value indicating that the corresponding process has a multi-level page table, the electronic device may perform a page table walk on the multi-level page table.

A description of the method of performing a page table walk on a multi-level page table is provided with reference to FIG. 3 and is generally applicable. In other words, a page table walk may be performed on a page table with a second level or more. In other words, a page table walk may be performed on a hierarchical page table. In this case, to take advantage of using a multi-level page table, as the page table walk goes to deeper levels, a page size of the multi-level page table may decrease. In other words, page granularity may increase down the page table hierarchy. For example, a page size of a 4-level page table may be less than a page size of a 2-level page table. For example, the page size may be 4 KB in a 4-level page table, 2 MB in a 3-level page table, and 1 GB in a 2-level page table.

In operation 550, the electronic device may update the TLB to include the virtual-physical address mapping found through whichever type of page table walk was performed. That is to say, the electronic device may update the TLB to include mapping information between the virtual address and the target physical address obtained through operation 530 or operation 540.

In operation 560, the electronic device may obtain the target physical address, for example, from the target physical address from the updated TLB or from the mapping information before it is added to the TLB.

At times, a new process may begin/resume being executed after operations 510 to 560 are performed. The electronic device may update the bit (or SPT flag) of the PTR when a new process is executed. For example, the bit of the PTR may be updated based on whether the new process is executed as a main process or an auxiliary process. For example, the bit of the PTR may be updated based on whether the new process is executed in the kernel space or in the user space.

Next, a system call in which the bit of the PTR is updated is described.

FIG. 6 illustrates an example of code flow for creation of a process, according to one or more embodiments.

An example using Linux kernel code is described. However, the following description is generally applicable to code related to creation of a process of other OSs. Moreover, while reference is made to process creation, the same technique may be applied to other execution units such as threads.

As described above with reference to FIGS. 1 to 5, for a process to use a single-level page table, a single-level page table may need to be allocated when creating the process. A new system call may be provided for creating a process that uses a single-level page table. For example, the new system call may be called fork_spt( ) (“spt” standing for single page table). As indicated by the system call name, the system call is a variation of the existing fork( ) system call.

The new system call may be used to implement a user command to run a new process as a main process. Thus, when a user command to run a process as a main process is received, the new system call (e.g., fork_spt( )) may be called. When the new system call is called, a single-level page table may be created. When the new system call is called, a page table address may be stored in the PTR, and the SPT flag of the PTR may be updated/set to 1. That is, when the main process is running, the page table address in the PTR may point to a single-level page table.

Specifically, the fork_spt( ) system call may call a kernel_clone( ) function (a kernel space clone function) by adding a flag called CLONE_SPT to a clone flag, thus enabling use of a single-level page table.

The kernel_clone( ) function may call a copy_process( ) function to clone a process. The copy_process( ) function may in turn call a copy_mm( ) function to copy the address space of the parent process to the child process. The copy_mm( ) function may handle creating a thread and creating a process separately. The copy_mm( ) function may allow the address space to be shared when creating a thread and may duplicate the address space when creating a process. When duplicating the address space, a dup_mm( ) function may be called, and its execution may involve duplicating a virtual address space (or a virtual memory address) instead of duplicating a physical memory. The dup_mm( ) function may call an allocate_mm( ) function and an mm_init( ) function to clone a virtual address space. The mm_init( ) function may call an mm_alloc_pgd( ) function, which may allocate a page table. The mm_init( ) function may check the clone flag and may create a single-level page table when the flag called CLONE_SPT is included in the clone flag (e.g., of the kernel_clone( ) function).

The examples described herein may be implemented using hardware components, software components, and/or combinations thereof. A processing device may be implemented using one or more general-purpose or special-purpose computers, such as, for example, a processor (e.g., a CPU, a GPU, an accelerator, or combinations of the like), a controller, an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular. However, one of ordinary skill in the art will appreciate that a processing device may include multiple processing elements and/or multiple types of processing elements. For example, a processing device may include a plurality of processors, or a single processor and a single controller. In addition, a different processing configuration is possible, such as one including parallel processors.

The software (in the form of instructions) may include a computer program, a piece of code, an instruction, or some combination thereof, to independently or collectively instruct or configure the processing device to operate as desired. The software and/or data may be stored in any type of machine, component, physical or virtual equipment, or computer storage medium or device for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the above-described examples may be recorded in non-transitory computer-readable media including program instructions to implement various operations of the above-described examples. The media may also include the program instructions, data files, data structures, and the like alone or in combination. The program instructions recorded on the media may be those specially designed and constructed for the examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) and a digital versatile disc (DVD); magneto-optical media such as floptical disks; and hardware devices that are specially configured to store and perform program instructions, such as read-only memory (ROM), RAM, flash memory, and the like. Examples of program instructions include both machine code, such as those produced by a compiler, and files containing higher-level code that may be executed by the computer using an interpreter.

The computing apparatuses, the electronic devices, the processors, the memories, the displays, the information output system and hardware, the storage devices, and other apparatuses, devices, units, modules, and components described herein with respect to FIGS. 1-6 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An operating method of an electronic device, the operating method comprising:
determining, in response to a process being executed, whether a mapping of a target physical address to a virtual address that the process is accessing is stored in a translation lookaside buffer (TLB);
determining, in response to determining that the virtual address is not stored in the TLB, whether the process uses a single-level page table; and
in response to determining that the process uses the single-level page table, obtaining the target physical address mapped to the virtual address based on accessing the single-level page table.

2. The operating method of claim 1, wherein the determining of whether the process uses a single-level page table is based on a register bit indicating a type of the process.

3. The operating method of claim 2, wherein the bit is set by a system call invoked based on a user command that causes the process to be executed using the single-level page table.

4. The operating method of claim 1, further comprising:
determining, in response to a second process being executed, whether a mapping of a second target physical address to a second virtual address that the second process is accessing is stored in the TLB;
determining, in response to determining that the second virtual address is not stored in the TLB, whether the second process uses a single-level page table; and
in response to determining that the second process does not use a single-level page table, obtaining the second target physical address mapped to the second virtual address based on a multi-level page table.

5. The operating method of claim 4, wherein a page size of the multi-level page table is less than a page size of the single-level page table.

6. The operating method of claim 4, wherein each level of the multi-level page table has a page size larger than each level below it.

7. The operating method of claim 1, wherein a virtual address space of the electronic device is divided into a kernel space and a user space, and wherein processes in the kernel space use multi-level page tables and processes in the user space use single-level page tables.

8. The operating method of claim 7, wherein the determining of whether the process uses a single-level page table depends on whether the virtual address is in the user space or is in the kernel space.

9. An electronic device comprising one or more host processors configured to:
determine, in response to a process being executed, whether a mapping of a target physical address to a virtual address that the process is accessing is stored in a translation lookaside buffer (TLB);
determine, in response to determining that the virtual address is not stored in the TLB, whether the process uses a single-level page table; and
in response to determining that the process uses the single-level page table, obtain the target physical address mapped to the virtual address based on accessing the single-level page table.

10. The electronic device of claim 9, wherein the one or more host processors are configured to:
determine, based on a bit in a page table register (PTR), that the process uses the single-level page table, wherein the electronic device is configured to perform a single-level page table walk when the bit has a first value and is configured to perform a multi-level page table walk when the bit has a second value.

11. The electronic device of claim 10, wherein the bit is set by a system call invoked based on a user command that causes the process to be executed using the single-level page table.

12. The electronic device of claim 9, wherein the one or more host processors are configured to:
determine, in response to a second process being executed, whether a mapping of a second target physical address to a second virtual address that the second process is accessing is stored in the TLB;
determine, in response to determining that the second virtual address is not stored in the TLB, whether the second process uses a single-level page table; and
in response to determining that the second process does not use a single-level page table, obtain the second target physical address mapped to the second virtual address based on a multi-level page table.

13. The electronic device of claim 12, wherein a page size of the multi-level page table is less than a page size used by the single-level page table.

14. The electronic device of claim 13, wherein each level of the multi-level page table has a page size larger than each level below it.

15. The electronic device of claim 9, wherein a virtual address space of the electronic device is divided into a kernel space and a user space, and wherein processes in the kernel space use multi-level page tables and processes in the user space use single-level page tables.

16. The electronic device of claim 15, wherein the determining that the process uses a single-level page table depends on whether the virtual address is in the user space or is in the kernel space.

17. A method performed by a computing device, the method comprising:
determining whether processes executing on the computing device use single-level page tables or whether they user multi-level page tables;
for each process determined to use a single-level page table, when a requested virtual address is not found in a translation lookaside buffer (TLB), using a corresponding single-level page table to determine the requested virtual address; and
for each processed determined to use a multi-level page table, when a requested virtual address is not found in the TLB, using a corresponding multi-level page table to determine the requested virtual address.

18. The method of claim 17, further comprising using a single-level page table to perform a first update of the TLB to include a mapping of a corresponding requested virtual address.

19. The method of claim 18, further comprising using a multi-level page table to perform a second update of the TLB to include a mapping of a corresponding requested virtual address.

20. The method of claim 17, wherein bit values of a page table register are checked, for the respective processes, to determine which of the processes use a corresponding single-level page table and which of the processes use a corresponding multi-level page table.
